(19) United States
(12) Patent Application Publication
(10) Pub. No.: US 2006/0242609 A1
(43) Pub. Date: Oct. 26, 2006

(54) Sync manager UI and updated API

(75) Inventors: David R. Potter, Bothell, WA (US); Kenneth W. Parker, Bellevue, WA (US); Rebecca J. Deutsch, Seattle, WA (US); Mohammed A. Samji, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/241,328

(22) Filed: Sep. 30, 2005

Related U.S. Application Data
(63) Continuation-in-part of application No. 11/111,939, filed on Apr. 22, 2005.

(51) Int. Cl. G06F 15/00

(52) U.S. Cl. 715/864; 712/40; 348/564

(57) ABSTRACT

A system and method are provided for presenting a centralized display that allows a user to quickly and easily manage user or application initiated sync operations for multiple devices. The invention may also provide a layered sync display, in which each layer presents a user with successively more information, including information about the event that occurred during the sync operations. The layered sync display ensures that a user is not presented with extraneous information, which simplifies management of the sync operations and allows user to perform other tasks during the sync operations. In implementations of the present invention, the sync operations may occur without user input, so that the user may continue working on other tasks while a sync operation takes place. The user may elect to enter input, to resolve conflicts, for instance, or other input requested by the sync operation, later when that is convenient for the user.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to a system and method for managing synchronization of devices and in particular to a system and method for providing a single aggregation point used to manage synchronization of multiple devices.

### BACKGROUND OF THE INVENTION

Computer users in today's environment may use a number of different computing devices. For example, a computer user may use a stationary computer terminal, a laptop computer, and a blackberry or other mobile device. Often, these computing devices are used to store similar or related information. For example, a calendar storing a user's appointment schedule may be present on a stationary computer terminal, a laptop computer, and a mobile device. As another example, a document may be stored on a stationary computer terminal and then copied to a laptop computer, where a user may edit the document.

After updating or altering information on one device, the user may wish to transfer the updated information to another device. In order to transfer information between devices, the user may choose to synchronize, or “sync,” two or more devices. One or more of the devices may contain a “sync manager,” which performs syncing operations. When two devices are synced, it is typically determined which device contains the most recent information. The device with the most recent information may, for example, transfer information to the other device.

Syncing is also useful in networking applications. For example, two or more users may have access to the same document, calendar, or other information in a networked computing environment. Syncing may be used in such an environment to ensure that the most recent copy of the information is used.

Conventionally, a user may connect a first device to a second device to begin a sync operation. For example, a user may rest a handheld device in a cradle which is connected to a computer terminal, may connect a laptop computer to a stationary computer terminal, or the like. The sync manager then begins to reconcile the different versions of files stored in the two devices. In some instances, the sync manager may reconcile versions of the files without user input, such as by determining which version of information has been most recently edited. In other instances, the sync manager requests input from the user in determining which version(s) of a file to keep.

While a sync operation is being performed, the user is typically presented with information detailing the status of the sync operation. For example, the user may be presented with a dialog box indicating that a sync operation is being performed, and containing a status bar indicating the progress of the sync operation.

In addition, the user interface presented to a user during a sync operation is typically prominent and may require input from the user during the sync operation. A user may not wish to be presented with a large, bulky display during a sync operation, for example, because the user may wish to perform other tasks.

Furthermore, a user wishing to perform multiple sync operations may be required, for example, to connect and sync each device in turn. Because the user may be required to sync each device in turn and provide input for each sync operation, syncing more than one device may prove to be a lengthy and cumbersome process. Also because each device may have to duplicate and store events such as exceptions, failures, or errors that have occurred during a sync operation into the storage provided and in a manner dictated by the sync manager, the sync operation is burdened with a sub-optimal operational condition. For instance, when a device running a sync handler encounters a communication error due to a network failure, it may have to save the event into its storage first. The sync handler must then duplicate the event and store the duplicate into the sync manager's storage for it to bring to the user's attention. Furthermore, each device may provide its own display presenting the user with information regarding sync operations. A user may therefore be required to access multiple displays to obtain sync information. For example, a user wishing to determine whether all sync operations were completed successfully may be required to access a laptop sync display, a Palm Pilot sync display, and a BlackBerry sync display.

On the other hand, when a sync operation is not initiated by users but is instead initiated in the background, for instance, by an external sync application, the information pertinent to such operation may not be made available for the users to view and act on. For instance, when a sync operation is initiated in the background between an external sync application and a sync server according to a predetermined schedule, users may not be aware of the operation and, therefore, cannot stop or cancel the operation.

There is therefore a need in the art for a centralized display that allows a user to quickly and easily manage sync operations for multiple devices. There is a further need in the art for a lightweight sync display that allows a user to perform other tasks during a sync operation.

### BRIEF SUMMARY OF THE INVENTION

Embodiments of the present invention include a method for displaying and managing information related to at least one user initiated or application initiated sync operation. The method may include displaying a first-layer graphical user interface presenting first information related to the at least one user initiated or application initiated sync operation, determining whether a user requests a second-layer graphical user interface, and, if the user requests a second-layer graphical user interface, displaying a second-layer graphical user interface presenting second information related to the at least one user initiated or application initiated sync operation.

In a further embodiment of the invention, a system for displaying information related to at least one user initiated or application initiated sync operation may include at least one sync handler being implemented in accordance with a sync application program interface. The system may further include a sync user interface configured to receive sync operation information from a plurality of sync handlers, to display a first-layer graphical user interface presenting first information related to the at least one user initiated or application initiated sync operation, and to display a second-layer graphical user interface presenting second information related to the at least one user initiated or application initiated sync operation.

In still further embodiments of the invention, a sync user interface is configured to receive information from a plurality of sync handlers and to display a tray icon presenting first information related to at least one user initiated or application initiated sync operation.

The foregoing systems and methods may provide a centralized display that allows a user to quickly and easily manage and act upon user initiated or application initiated sync operations for multiple devices. The invention may also provide a layered sync display, in which each layer presents a user with successively more information. The layered sync display may ensure that a user is not presented with extraneous information, which simplifies management of sync operations and allows user to perform other tasks during sync operations.

In implementations of the present invention, sync operations may occur without user input, so that the user may continue working on other tasks while a sync operation is taking place. The user may elect to enter input, such as input used to resolve conflicts or other input requested by the sync operation, at a later time that is convenient for the user. Sync operations may also be initiated in the background, for instance, by an external sync application without user initiation. Therefore, the user may also act on the background initiated sync operation through the layered sync display.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is block diagram illustrating a computerized environment in which embodiments of the invention may be implemented;

FIGS. 3-5 display exemplary graphical user interfaces (GUIs) in accordance with an embodiment of the invention; and

FIG. 6 is a flow chart illustrating a method for performing a sync operation in accordance with an embodiment of the invention.

### DETAILED DESCRIPTION OF THE INVENTION

I. System Overview

A system and method are provided for implementing a sync manager. The sync manager may be used to sync two or more devices, folders, or other data sources.

The system may include a terminal 200, which includes a sync manager 201. The terminal 200 may be connected to one or more devices 202, 204 via couplings 206, 208, respectively. Each device 202, 204 may be or include, for example, a mobile communication device, a laptop computer, a gaming device, a camera, a computer terminal, or the like. A sync operation may begin, for example, when a user connects the device 202 to the terminal 200 via the coupling 206 and/or connects the device 204 to the terminal 200 via the coupling 208.

The sync manager 201 contains a Sync Application Program Interface (API) 218 that contains objects and methods used in a sync operation. The objects included in the Sync API may include, for example, one or more Sync Handlers 220, 222, 224, each of which specifies how a sync operation is to be performed, for example, by providing the logic necessary to link with a particular device, folder, or other data source. The objects included in the Sync API may also include, for example, one or more Sync Monitors 226, 228, 230, each of which monitors a device, folder, or other data source to determine when a sync operation should be performed.

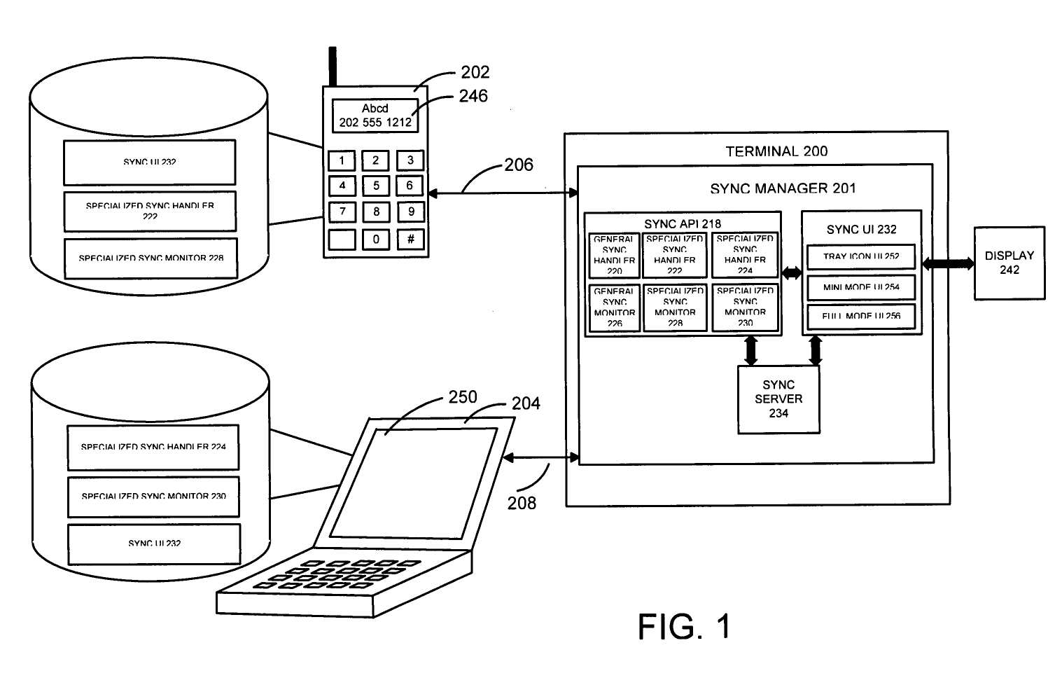

The Sync API 218 may include a general Sync Handler 220, for example, which is the default sync handler used in performing a sync operation. The Sync API 218 may also be or include an extensible API that is extended, for example, to create specialized sync handlers for particular devices and/or applications. As a particular example, BlackBerry developers can write a sync handler specifying how sync operations including a Blackberry are to be performed. As shown in FIG. 1, specialized Sync Handler 222 may be an extension of the Sync API 218 that is used to perform sync operations originating from the device 202. Sync Handler 222 may be stored, for example, on the terminal 200, in the device 202, or in both locations. As another example, specialized Sync Handler 224 may be an extension of the Sync API 218 that is used to perform sync operations originating from the device 204. Specialized Sync Handler 224 may be stored, for example, on the terminal 200, in the device 204, or in both locations.

The Sync API 218 may also include a general Sync Monitor 226, for example, which is the default sync monitor used to determine when a sync operation should take place. The Sync API 218 may also be or include an extensible API that is extended, for example, to create specialized sync monitors for particular devices and/or applications. As a particular example, BlackBerry developers can write a sync monitor specifying how when sync operations including a Blackberry are to be performed. As shown in FIG. 1, specialized Sync Monitor 228 may be an extension of the Sync API 218 that is used to perform sync operations originating from the device 202. Sync Monitor 228 may be stored, for example, on the terminal 200, in the device 202, or in both locations. As another example, specialized Sync Monitor 230 may be an extension of the Sync API 218 that is used to perform sync operations originating from the device 204. Specialized Sync Monitor 230 may be stored, for example, on the terminal 200, in the device 204, or in both locations.

When one or more of the Sync Monitors 226, 228, 230 determines that a sync operation should occur, a Sync User Interface (UI) 232 may alert a user. The Sync UI 232 may be stored, for example, on the terminal 200, the device 202, and/or the device 204. The Sync UI 232 may alert the user, for example via a display 242, 246, and/or 250 included in or connected to the terminal 200, device 202, or device 204, respectively. The user may then choose to initiate the sync operation. Alternately or in addition, the Sync Monitors 226, 228, 230 may automatically initiate the sync operation. In an embodiment, sync operations can be also initiated in the background between a sync server 234 and an external sync application that is running in device 202 or device 204. Sync operations can also be initiated in the background by the sync server 234 in response to changes in system environment or changes on particular data sources, or in response to a schedule or some other event, such as a network connection being established or the machine reaching an idle state. The user may view and act on the background initiated sync operation in the same manner in which user initiated sync operations can be viewed and acted upon.

Sync operations are performed by the Sync Server 234 using methods specified in one or more of the Sync Handlers 220, 222, 224. In performing sync operations, the Sync Server 234 may cache one or more of the Sync Handlers 220, 222, 224 to expedite sync operations.

During a sync operation, one or more of the Sync Handlers 220, 222, or 224, or one or more external sync applications may report to the sync manager 201, which, in turn, may present to users via display 242 various events such as exceptions, failure, or errors that have occurred during sync operations. This centralized event reporting arrangement provides an extensibility mechanism that allows a sync handler to either report its events directly or provide them through their own store.

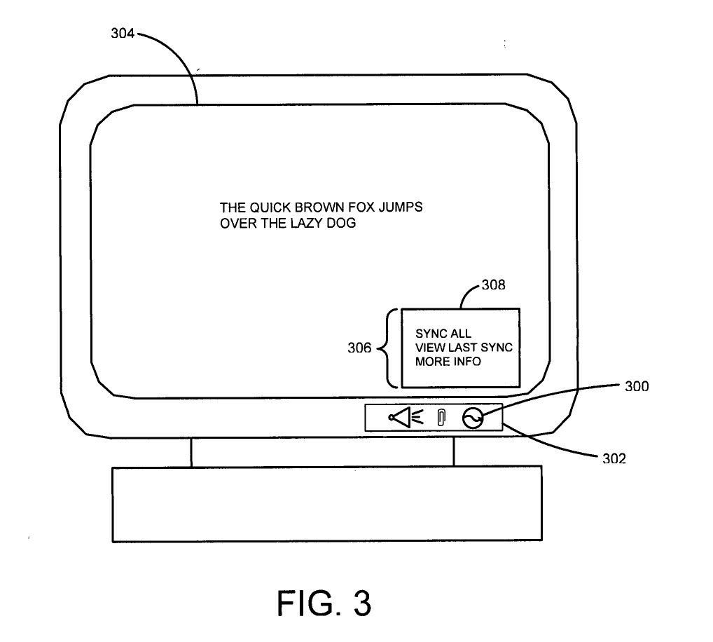

As sync operations occur, the Sync UI 232 may present information to a user via one or more of the displays 242, 246, 250. In one implementation, the Sync UI 232 has a layered structure, and includes a plurality of UI components 252, 254, 256. For example, the Sync UI 232 may include a first-layer UI component 252, which may present a user with a first-layer GUI such as a tray icon. The Sync UI 232 may also include a second-layer UI component 254, which may present a user with a second-layer GUI, such as a “mini-mode” that includes more information than the first-layer GUI. The Sync UI 232 may further include a third-layer UI component 256, which may present a user with a third-layer GUI, such as a “full-mode” that includes still more information. The first-, second-, and third-layer GUIs will be discussed further hereinbelow with reference to FIGS. 3-5.

In displaying information to a user, the Sync UI 232 may cache one or more of the Sync Handlers 220, 222, 224 to expedite the display.

In implementations of the present invention, developers may extend the Sync UI 232, for example, by specifying additional information or user options to be presented by the second-layer UI component 254 and/or the third-layer UI component 256. This allows developers to utilize the Sync UI 232 to present data relevant to a particular device.

II. Exemplary Operating Environment

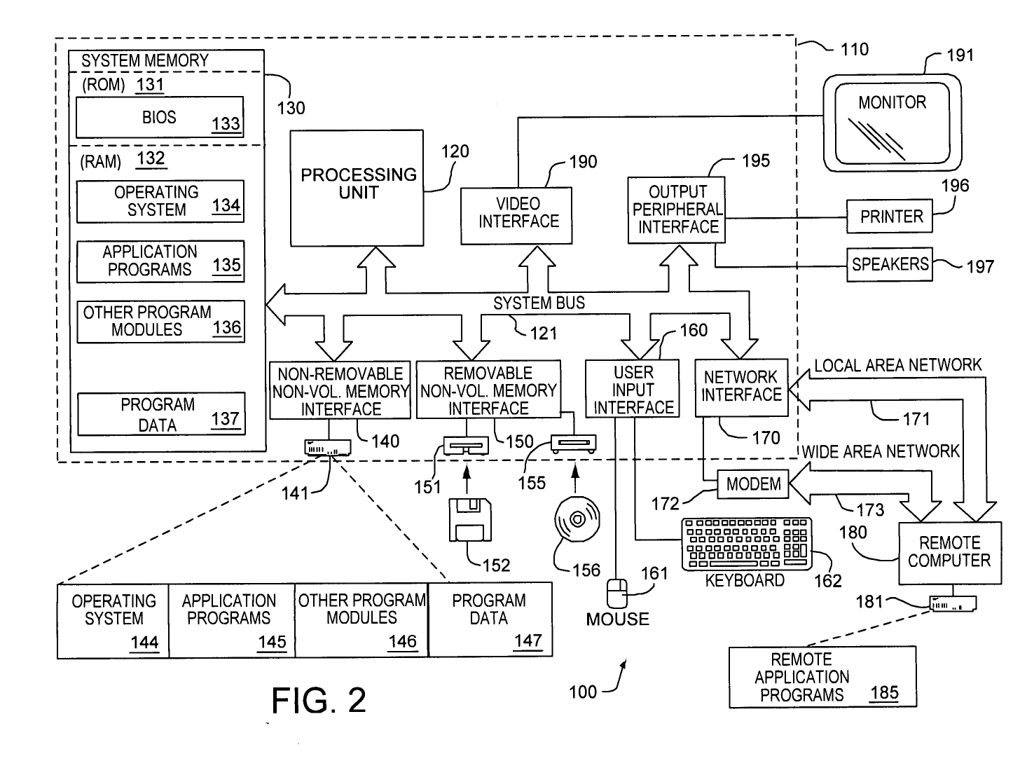

FIG. 2 illustrates an example of a suitable computing system environment 100 on which the sync manager UI and API may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. Systems and Methods of the Invention

As set forth above, FIG. 1 illustrates a system for implementing a sync manager in accordance with an embodiment of the invention. As described above with respect to FIG. 2, the system may include one or more user computers.

FIGS. 3-5 display exemplary GUIs, in accordance with an embodiment of the invention. As discussed with reference to FIG. 1, the Sync UI 232 may include first-, second-, and third-layer UI components 252, 254, and 256, which may display first-second, and third-layer GUIs, respectively.

The first-layer UI component 252 may present a user with a first-layer GUI, such as a tray icon 300, as shown in FIG. 3. The tray icon 300 may be, for example, the user interface typically presented during a sync operation. The tray icon 300 may be presented, for example, in a system tray 302 or on a display 304, and may indicate the status of one or more sync operations. For example, the tray icon 300 may become illuminated or rotate when one or more sync operations is in progress. In addition, the tray icon 300 may change colors upon completion of sync operations. The color of the tray icon 300 may also be used to indicate the status of the sync operations. For example, the tray icon 300 may become green to indicate that all sync operations were completed successfully, become yellow to indicate that user input is requested, or become red to indicate that an error occurred during one or more sync operations.

Because the tray icon 300 may be out-of-the-way and non-intrusive, the user may be free to perform other tasks, for example, via the display 304.

A user may also use the tray icon 300 for example, to select common tasks 306 associated with sync operations. Common tasks 306, such as, for example, a “sync all” task that initiates a sync operation with all connected devices, may be presented to the user via the tray icon 300. A user may select a common task 306, for example, by right-clicking on the tray icon 300 and selecting the common task 306 from a drop-down menu 308, or by some other appropriate method.

The tray icon 300 is one example of a lightweight, out-of-the-way interface that may be presented to a user to indicate the status of a sync operation. If the user requires more information than that provided by the tray icon 300, the user may enter a “mini-mode,” for example, by double-clicking on the tray icon, by selecting “more info” from the drop-down menu 308, or by some other appropriate method.

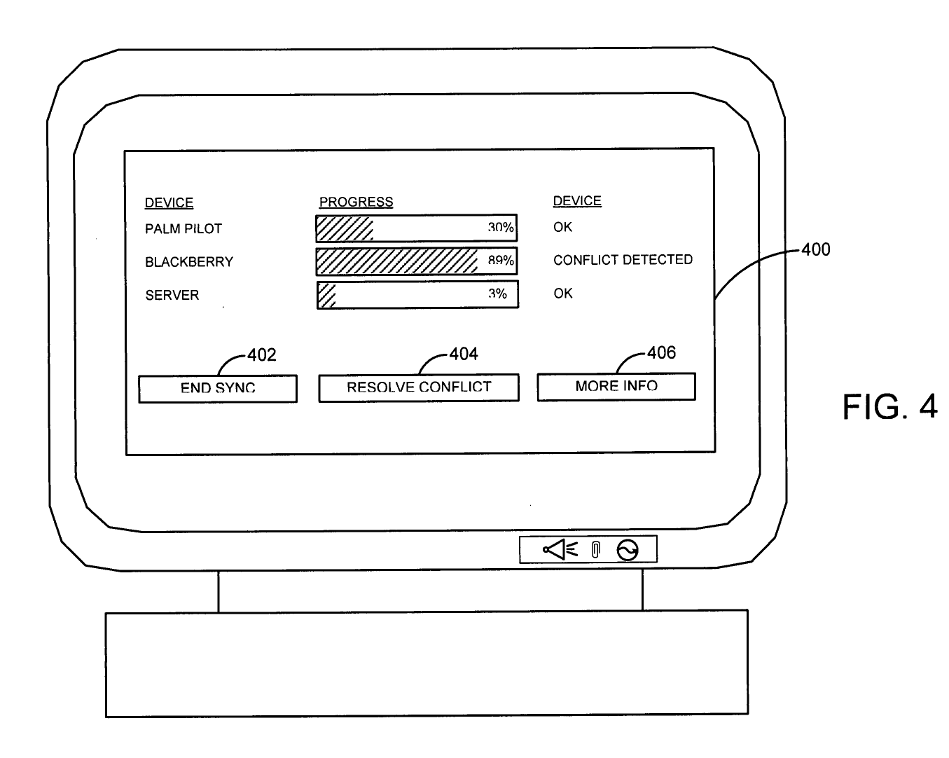

As shown in FIG. 4, a mini-mode 400 may be a second-layer GUI presented by the second-layer UI component 254. The mini-mode 400 may be or include, for example, a small GUI that provides further detail about sync operations. If a sync operation is in progress, for example, the mini-mode 400 may present the user, for example, with a list of devices being synced and with information about the progress and status of each separate sync operation. If a sync operation is not in progress, the mini-mode 400 may present the user with information describing, for example, the status of the last sync operation and/or the last time a successful sync operation was completed with each device. The mini-mode 400 may also allow a user to select from one or more tasks, such as, for example, ending the sync operation 402, resolving a conflict 404, or obtaining more information 406. The tasks presented to the user by the mini-mode 400 may include, for example, one or more of the common tasks accessible from the tray icon, in addition to less-frequently used tasks.

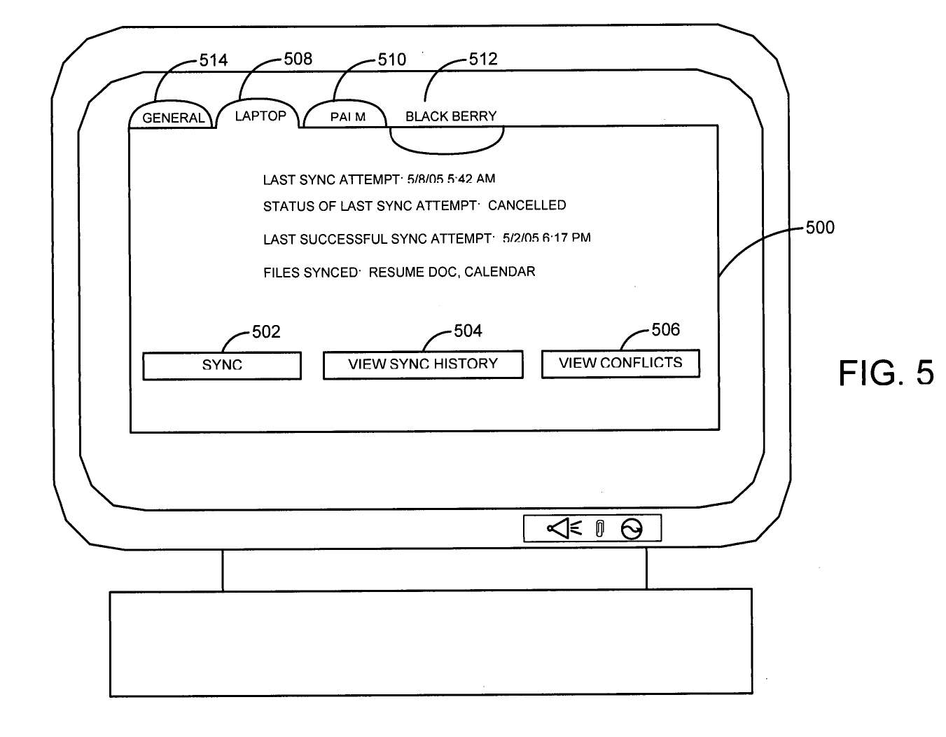

If the user desires more information than is available in the mini-mode, the user may access a “full view,” for example, by selecting an option 406 in the mini-mode 400 or by some other appropriate method. As shown in FIG. 5, a full view 500 may be a third-layer GUI presented by the third-layer UI component 256. The full view 500 may provide the user with still further detail about sync operations, such as specific error information and the like. In addition, the full view may allow the user to select from full-view tasks 502, 504, 506, which may be, for example, all tasks available to the user, including the common tasks available from the tray icon 300, the less frequently used tasks available from the mini-mode 400, and rare tasks, which may only be available through the full view 500.

In implementations of the full mode 500, a user may be able to separately view information for a particular device, for example, by clicking on a tab 508, 510, 512 or by some other appropriate method. A user may be able to view general sync information, for example, by clicking on a general tab 514 or by some other appropriate method. Each of the tabs 508, 510, 512, 514 may allow the user to select one or more full-view tasks 502, 504, 506.

In implementations of the present invention, developers may extend the Sync UI 232, for example, by specifying additional information or user options to be presented by the in the mini-mode 400 and/or the full mode 500. This allows developers to utilize the Sync UI 232 to present data relevant to a particular device.

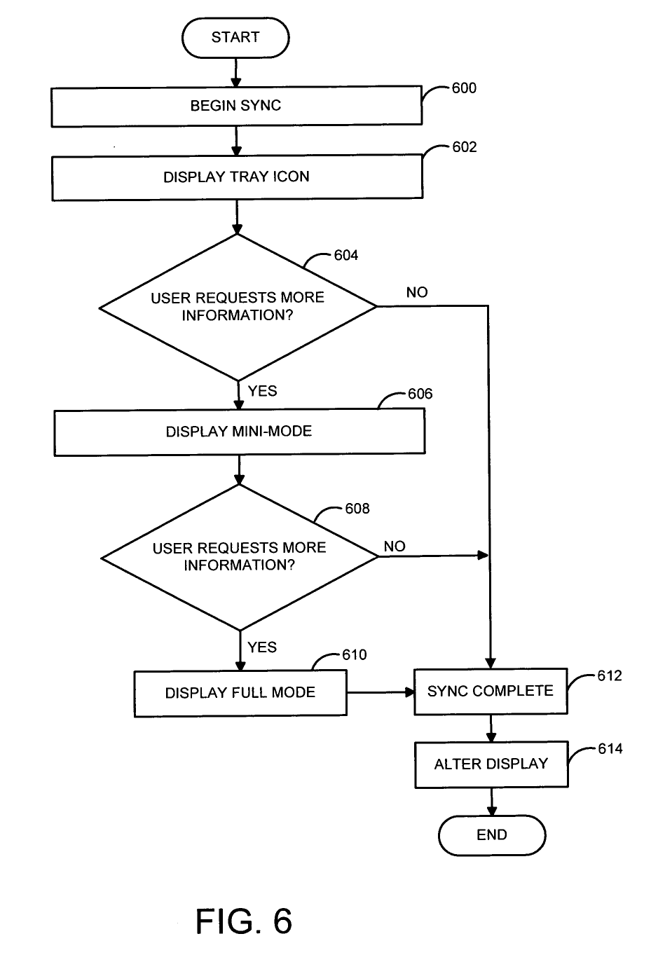

FIG. 6 is a flow chart illustrating a method for performing a sync operation in accordance with an embodiment of the invention. As shown in FIG. 6, one or more sync operations may begin in step 600, for example, when a user connects two or more devices, selects an option to initiate sync operations, or otherwise initiates sync operations. In step 602, a tray icon or other GUI may be displayed to a user to indicate that sync operations are in progress. The tray icon or other first-layer GUI displayed in step 602 may be, for example, the GUI presented by a first-layer UI component. In implementations of the present invention, a tray icon is presented to a user in a system tray, and upon initiation of a sync event, the tray icon brightens, spins, or is otherwise indicates that sync operations are in progress. The tray icon may also allow the user to select common tasks.

In step 604, the user may request more information than the information provided by the tray icon or other first-layer GUI. If the user requests more information in step 604, a mini-mode or other second-layer GUI may be displayed in step 606. The mini-mode or other second-layer GUI may, for example, display more information than the tray icon or other first-layer GUI. In addition, the mini-mode or other second-layer GUI may present the user with the option to select additional tasks not presented in the tray icon or other first-layer GUI.

In step 608, the user may request more information than the information provided by the mini-mode or other second-layer GUI. If the user requests more information in step 608, a full mode or other third-layer GUI may be displayed in step 610. The full mode or other third-layer GUI may, for example, display more information than the mini-mode or other second-layer GUI. In addition, the full mode or other third-layer GUI may present the user with the option to select additional tasks not presented in the mini-mode or other second-layer GUI.

While sync operations are in progress, the tray icon or other first-layer GUI, the mini-mode or other second-layer GUI, and/or the full mode or other third-layer GUI may present the user with information regarding the progress or status of sync operations. For example, a tray icon may remain bright or continue spinning during sync operations, and may change its color if user input is required, such as in the case of a conflict. As another example, progress bars or status listings of various sync operations in the mini-mode or in the full-mode may change to reflect sync operations in progress. Other examples are possible.

In step 612, sync operations are completed, and in step 614, one or more displays are altered to alert the user to the completion of the sync operation. For example, a tray icon may reduce its brightness and stop spinning, or may change its color, for example, to green to indicate that sync operations were successfully completed or to red to indicate that sync operations were unsuccessful. As another example, the mini-mode or the full mode may be altered to indicate the completion of sync operations.

While particular embodiments of the invention have been illustrated and described in detail herein, it should be understood that various changes and modifications might be made to the invention without departing from the scope and intent of the invention. For example, while the invention has primarily been described in terms of mobile devices connecting to a stationary computer terminal, the invention is equally suited to other environments, such as a network of computer terminals or other appropriate environment. In addition, while the devices have been described as being connected via couplings, any method of communication, such as, for example, wireless communication, is suitable. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for displaying information related to at least one user initiated or application initiated sync operation, the method comprising:
displaying a first-layer graphical user interface presenting first information related to the at least one user initiated or application initiated sync operation;
determining whether a user requests a second-layer graphical user interface; and
if the user requests the second-layer graphical user interface, displaying the second-layer graphical user interface presenting second information related to the at least one user initiated or application initiated sync operation.

2. The method of claim 1,
wherein the first information comprises aggregate information relating to the status of the at least one user initiated or application initiated sync operation, and
wherein the second information displayed by the second graphical user interface is specified by a handler in accordance with a sync application program interface.

3. The method of claim 1, wherein the first-layer graphical user interface comprises one or more first user-selectable options selectable to initiate a task related to the at least one user initiated or application initiated sync operation.

4. The method of claim 1, wherein the second-layer graphical user interface comprises one or more second user-selectable options selectable to initiate a task related to the at least one user initiated or application initiated sync operation.

5. The method of claim 4, wherein the one or more second user-selectable options are specified by a handler in accordance with a sync application program interface.

6. The method of claim 1, wherein the first information and the second information comprise information relating to the event that occurred during the at least one user initiated or application initiated sync operation.

7. The method of claim 1, further comprising:
determining whether a user requests a third-layer graphical user interface; and
if the user requests the third-layer graphical user interface, displaying the third-layer graphical user interface presenting third information related to the at least one user initiated or application initiated sync operation.

8. The method of claim 7, wherein the third-layer graphical user interface comprises one or more third user-selectable options selectable to initiate a task related to the at least one user initiated or application initiated sync operation.

9. The method of claim 8, wherein the one or more third user-selectable options are specified by a handler in accordance with a sync application program interface.

10. The method of claim 7,
wherein the third information comprises information relating to the event that occurred during the at least one user initiated or application initiated sync operation, and
wherein the third information displayed by the third graphical user interface is specified by a handler in accordance with a sync application program interface.

11. A system for displaying information related to at least one user initiated or application initiated sync operation, the system comprising:
at least one sync handler being implemented in accordance with a sync application program interface; and
a sync user interface configured to receive sync operation information from a plurality of sync handlers, to display a first-layer graphical user interface presenting first information related to the at least one user initiated or application initiated sync operation, and to display a second-layer graphical user interface presenting second information related to the at least one user initiated or application initiated sync operation.

12. The system of claim 11,
wherein the first information comprises aggregate information relating to the status of the at least one user initiated or application initiated sync operation, and
wherein the second information displayed by the second graphical user interface is specified by the at least one sync handler.

13. The system of claim 11, wherein the first-layer graphical user interface comprises one or more first user-selectable options selectable to initiate a task related to the at least one user initiated or application initiated sync operation.

14. The system of claim 11, wherein the second-layer graphical user interface comprises one or more second user-selectable options selectable to initiate a task related to the at least one user initiated or application initiated sync operation.

15. The system of claim 11, wherein the first information and the second information comprise information relating to an event that occurred during the at least one user initiated or application initiated sync operation that was reported to a sync manager or provided by a separate event store.

16. The system of claim 11,
wherein the sync user interface determines whether a user requests a third-layer graphical user interface; and
wherein, if the user requests the third-layer graphical user interface, the sync user interface displays the third-layer graphical user interface presenting third information related to the at least one user initiated or application initiated sync operation.

17. The system of claim 16, wherein the third-layer graphical user interface comprises one or more third user-selectable options selectable to initiate a task related to the at least one user initiated or application initiated sync operation.

18. The system of claim 16,
wherein the third information comprises information relating to an event that occurred during the at least one user initiated or application initiated sync operation that was reported to a sync manager or provided by a separate event store, and
wherein the third information displayed by the third graphical user interface is specified by a handler in accordance with a sync application program interface.

19. A sync user interface configured to receive information from a plurality of sync handlers and to display a tray icon presenting first information related to at least one user initiated or application initiated sync operation.

20. The sync user interface of claim 19, wherein the first information comprises aggregate information relating to the status of the at least one user initiated or application initiated sync operation.
